(19) United States
(12) Patent Application Publication
(10) Pub. No.: US 2018/0279566 A1
(43) Pub. Date: Oct. 4, 2018

(54) Wireless Solenoid Mesh Network

(71) Applicant: Rain Bird Corporation, Azusa, CA (US)

(72) Inventors: John James Wlassich, Pasadena, CA (US); Randy Ray Montgomery, Tucson, AZ (US); Chong Wang Kwak, Tucson, AZ (US)

(21) Appl. No.: 15/937,267

(22) Filed: Mar. 27, 2018

Related U.S. Application Data
(60) Provisional application No. 62/477,893, filed on Mar. 28, 2017.

(51) Int. Cl. A01G 25/16; F16K 31/06; G05B 15/02; H04L 29/08

(52) U.S. Cl. CPC A01G 25/16; F16K 31/0644; H04L 67/125; A01G 25/167; G05B 15/02

(57) ABSTRACT

There is provided an irrigation system with a plurality of solenoid valves. The solenoid valves each include a wireless transceiver that communicates with one another to form a mesh network. The solenoids can include sensors that gather data to be communicated over the wireless mesh network to a controller. The solenoids can also include a signal generator to activate passive sensors remote from the solenoid to collect data and transmit the data to the solenoid for communication over the wireless mesh network to a controller. The data can be related to environmental conditions or security about the irrigation system.

### CROSS-REFERENCE To RELATED APPLICATIONS

This application claims benefit of U.S. Provisional Application No. 62/477,893, filed Mar. 28, 2017, which is hereby incorporated herein by reference in its entirety.

### FIELD

The subject matter of this application relates to solenoids for valves of irrigation systems and, more particularly, to a solenoid with wireless communication capability to form a wireless mesh network.

### BACKGROUND

Irrigation systems are primarily used in the monitoring and controlling of watering of vegetation, such as landscapes, gardens, golf courses, municipal parks, and sports venues. Irrigation systems include valves, wires, pipes, sensors, controllers, gateways, and water emission devices (e.g., sprinklers, drip emitters, and rotors). The valves are typically controlled electronically by a solenoid. In a conventional irrigation system, solenoids are typically wired to a controller and the power and signal to actuate them is transmitted via the wires. The controllers include schedules that turn on and off the valves for controlling irrigation. The controller also can adjust schedules and override schedules based on sensor readings, weather conditions, and/or other variables.

In a typical irrigation system, as water flows through the irrigation piping, it can be diverted at different points to feed water to individual areas or “zones.” In each zone, the pipe can connect to a valve and is controlled by a solenoid mounted thereon. The valves with their associated solenoids may be housed in a valve box that is disposed in the ground with the top of the valve box being flush with the ground level. The valve can be activated by the controller sending power to the solenoid. In addition, in some systems, the valves are wired in series. In this case, the controller sends an analog signal along the wire representing a particular valve to be activated, and this signal is decoded at the valve. Generally, the wiring is a 24 AC power line.

One shortcoming is the ability to send data sensed in the irrigation zones back to the controller. It can be wirelessly sent when the sensors are in range. But, when the irrigation area is large, the wireless capability may not be able to reach the controller. There is a desire to address this communication shortcoming.

Another shortcoming can arise when adding new zones to the irrigation system. Typically, new water pipes can easily tap into existing pipes in neighboring zones and, therefore, do not require trenches to be dug to install pipes all the way back to the main water supply. However, installing the wiring requires cumbersome digging of new trenches and laying new wiring in order to couple the controller to the new valves. Additionally, wires deteriorate over time and are susceptible to damage from human and animal interaction with the ground in the irrigation zone, thereby causing the irrigation system to possibly fail. Furthermore, when irrigation wires are buried underground they can be hard to locate, and any maintenance requires an additional burden of using special equipment to locate the wires. There is a desire to address this shortcoming.

### BRIEF DESCRIPTION OF THE DRAWINGS

FIG. 1 is a schematic diagram of an irrigation system with a wireless solenoid mesh network;

FIG. 2 is a schematic diagram of the wireless communication between solenoids of the wireless solenoid mesh network of FIG. 1;

FIG. 3A is a plan view of a printed circuit board for controlling functionality at a valve, including the ability to wirelessly transmit and receive data;

FIG. 3B is a plan view of an alternate printed circuit board for controlling functionality, including the ability to wirelessly transmit and receive data;

FIG. 4 is a perspective view of the printed circuit board of FIG. 3B folded into a sandwiched configuration;

FIG. 5 is a perspective view of an irrigation valve and a solenoid with the printed circuit board of FIG. 4 integrated into an enclosure of a solenoid;

FIG. 6A is a perspective view of the solenoid with the printed circuit board integrated into the enclosure of the solenoid of FIG. 5;

FIG. 6B is a perspective view of an alternative solenoid with the printed circuit board of FIG. 3B wrapped around an enclosure of the solenoid; and

FIG. 7 is a perspective view of an irrigation valve using the solenoid of FIG. 6A, piping attached to the valve and a flow sensor downstream of the valve.

### DETAILED DESCRIPTION

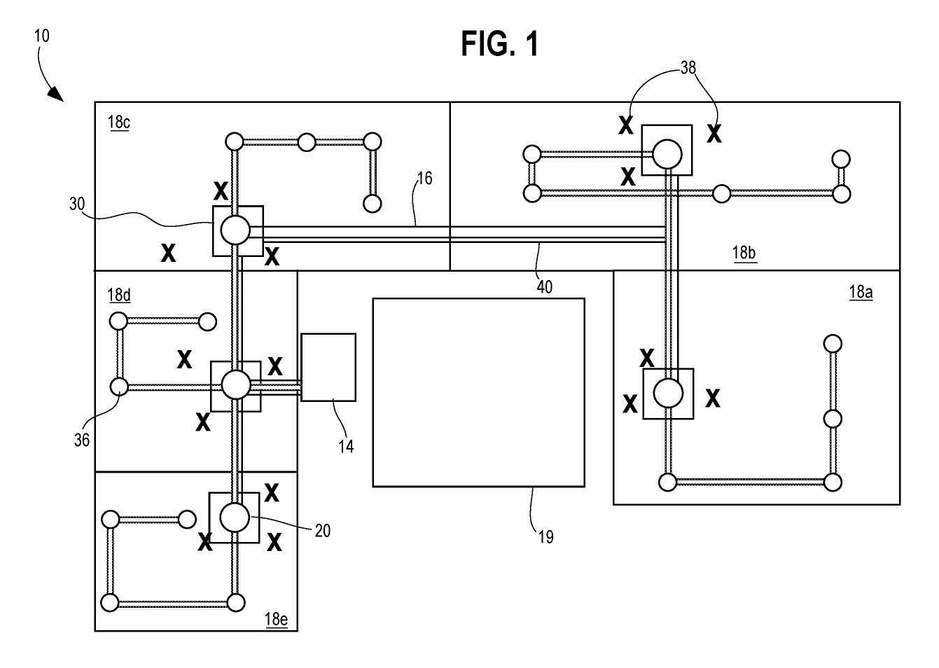

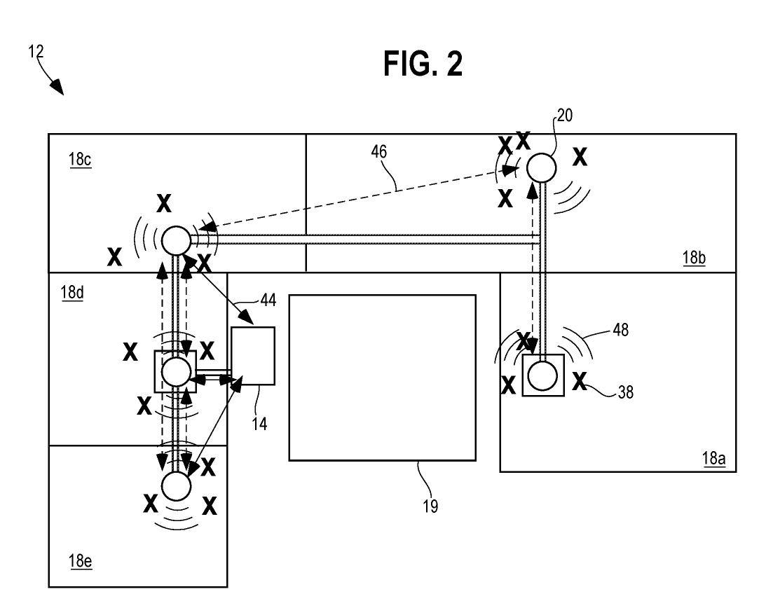

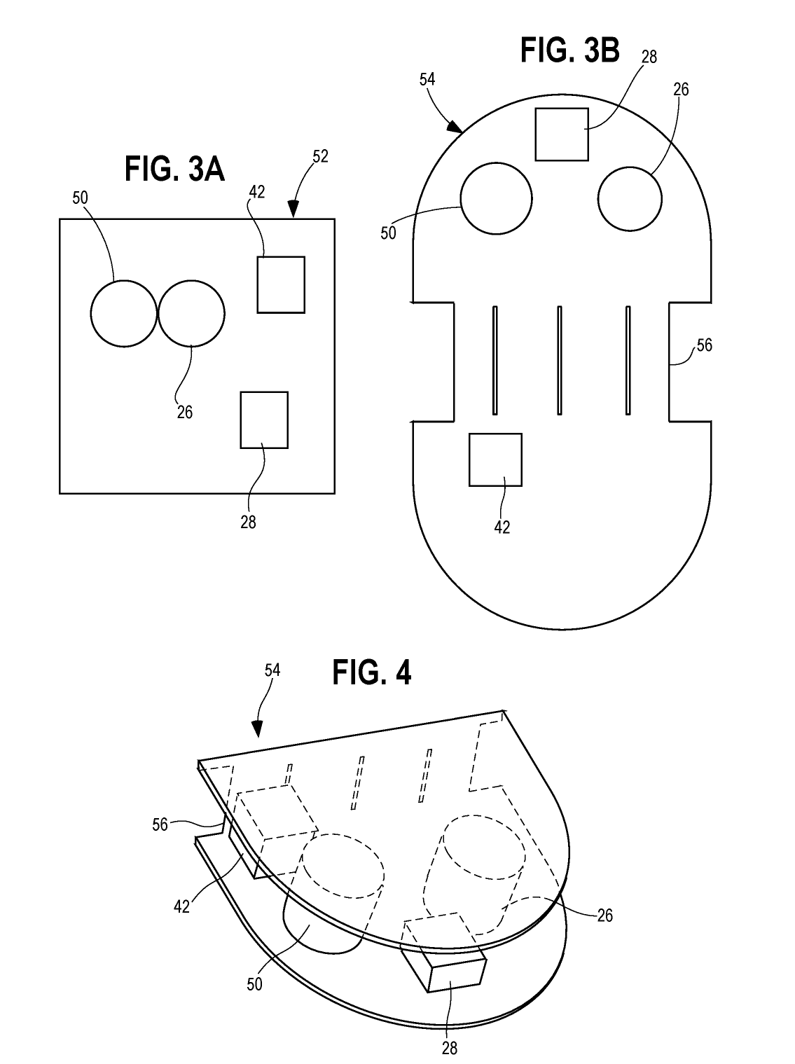

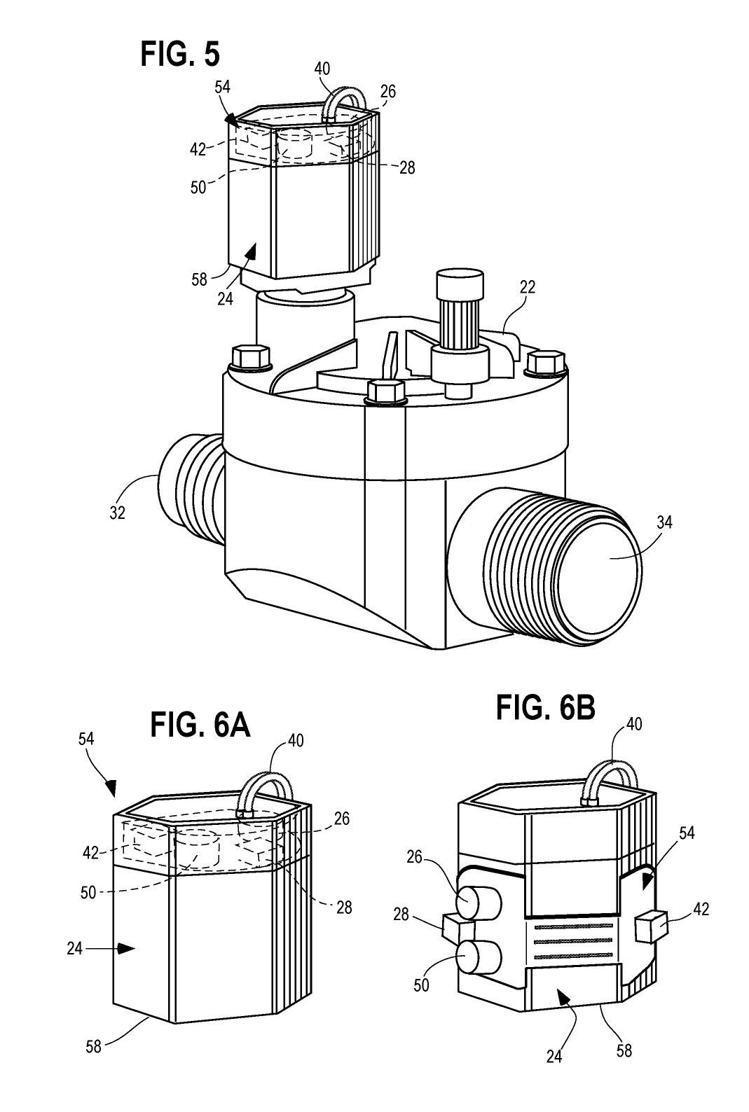

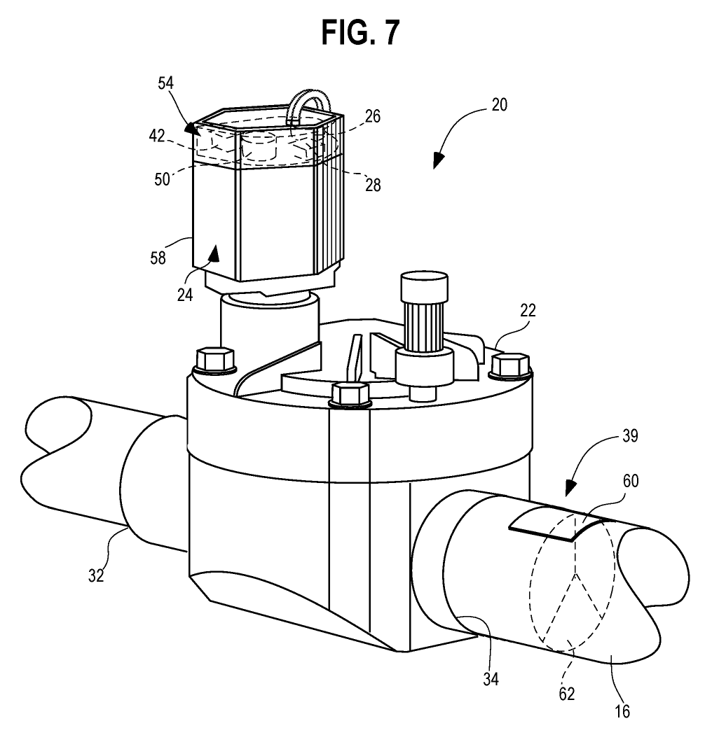

Referring to FIG. 1, there is illustrated an irrigation system 10 configured with a wireless solenoid mesh network 12 (FIG. 2). The irrigation system 10 includes a controller 14, piping 16, and a plurality of zones 18a-e. Each zone 18 represents an area of land and may include a valve node 20. Each valve node 20 may include a valve 22 with a solenoid 24 (FIG. 5), one or more sensors 26 and a transceiver 28 (FIG. 3B). The valve sensor node 20 may be housed in a valve box 30. The valves nodes 20 each have an inlet 32 and an outlet 34 (FIGS. 5 and 7) where the piping 16 is connected, allowing for the flow of water to irrigation devices 36. Irrigation devices 36 can include rotors, sprinklers, and drip emitters.

The irrigation system 10 also can include passive sensors 38 located in the vicinity of the valve nodes 20 to be activated by the valve node 20 and report certain conditions to the valve node 20, as described further below. The solenoids 24 of the valves 22 are activated by the controller 14 through wiring 40. The valves with the solenoid 24 could be integrated into the emission device itself. For example, a rotor could be fitted with an embedded valve using solenoid 24.

The solenoid 24 can be used to upgrade an existing irrigation system so it includes the solenoid mesh network 12. To accomplish this, one would replace the conventional solenoids of the existing irrigation system with the wireless capable solenoids 24. This would allow the irrigation system to then communicate using the wireless solenoid mesh network 12. In addition, existing irrigation systems can be easily expanded using the communication capability of the solenoid mesh network 12. For instance, additional zones could be added using the solenoid 24 to expand the wireless solenoid mesh network 12. Further, the entire irrigation system could be made wireless if the solenoids are fitted with local power, e.g., include charge retaining batteries and/or capacitors and solar charging capability. In this fully wireless situation, it would desirable to use a latching type solenoid to reduce power consumption.

The valve nodes 20 can provide data back to the controller 14. This data can pertain to altering the functionality of the irrigation system, such as irrigation schedules and irrigation overrides. It also can pertain to security for the irrigation system or a structure 19, such as a home or other building, contained within the perimeter of the valve nodes 20. That is, the valve nodes 20 can provide information about intrusions occurring near or inside the irrigation area. In designing an irrigation system, it may be beneficial to consider the location of the valve nodes 20, such as placing them near the perimeter of the property.

The controller 14 is typically at the location of the irrigation system 10. It may be configured to be controlled remotely via a mobile device (e.g., a smartphone or tablet) or a central control system. It also may include a gateway to communicate with the mobile device or the central control system. The wireless solenoid mesh network 12 may communicate with the controller 14 or the gateway. The gateway may be in communication with a cellular network.

The controller can dictate when to turn the water flow on or off based on schedules sensor readings, and/or climate conditions. As mentioned above, wiring 40 can send power to operate the solenoid 24. The wiring 40 can be configured to directly pair the controller 14 and valve node 20. Alternatively, the wiring 40 can be configured to connect the valve nodes 20 in series, where a decoder 42 (FIG. 3B) at the valve node 20 will receive an analog signal transmitted along the wiring 40 corresponding to its identification code and activate the solenoid 24.

With reference to FIG. 2, the wireless solenoid mesh network 12 is configured to allow wireless communication between the valve nodes 20 and the controller 14. This circumvents the bottleneck of having to transmit data from the field back through the two-wire system. Each node can wirelessly communicate directly with the controller (reference number 44) if in range. When out of range, the sensor nodes 20 can wirelessly communicate with the controller through other solenoids in wireless solenoid mesh network 12 (reference number 46).

The wireless solenoid mesh network 12 can determine the route by which data is communicated back to the controller 14. For example, if a desired communication path would go through a valve node 20 that is busy, the data will take a different route even though it may be less direct. Further, if a valve node 20 is offline or defective for some reason, the wireless solenoid mesh network 12 will self-heal by providing an alternate route around the offline or defective valve node 20. Finally, the wireless solenoid mesh network 12 may have distributed intelligence to make decisions based on the routed data.

As mentioned above, passive sensors 38 can reside outside of the valve box 30 and are not directly wired to the valve nodes 20. The sensors 38 can be in close enough proximity to one of the valve nodes 20 so that when an electromagnetic wave of radio frequency 48 is emitted by the valve node 20, the sensor 38 wakes up and performs its programmed tasks, such as collecting data and transmitting the data to the valve node 20. The sensor 38 may remain alert for incoming data from the valve node 20, and send data back to the valve node 20 based upon changes in the data. The wiring 40 providing power to energize the solenoids 24 can also supply power to generate the electromagnetic wave of radio frequency 48 to activate the passive sensors 38. This uses what is referred as radio-frequency identification (RFID) technology. In this manner, the sensors 38 can collect electromagnetic energy to briefly turn on, collect data, and transmit data back to the valve node 20 without requiring a battery. This data in turn can be transmitted back to the controller 14 through the wireless solenoid mesh network 12.

The sensors 26 of the valve node 20 or remote sensors 38 can be selected to provide a multitude of information and functions, including: detecting tampering of the irrigation devices, alerting of unwanted intruders, and determining flow, moisture, humidity, solar radiation, wind, temperature, and evaporation data. For instance, if a sensor 26, 38 detects that the soil is too dry, the controller 14 receives this data through the wireless solenoid mesh network 12 and sends a signal back through the network 12 instructing the appropriate valve node 20 to open its valve 22. Water can then flow through that valve 22 and into the piping 16 which continues from the valve outlet 34 to supply water to the water emission devices 36 along the piping 16 in the zone.

With reference to FIG. 3A, there is illustrated a printed circuit board 52 of rectangular shape which may contain micro-electronics, including a transceiver 28, a sensor 26, a decoder 42 and a signal generator 50 for generating electromagnetic waves of radio frequency 48. The transceiver 28 may operate using any convention wireless communication technology, such as WiFi, Low Energy Bluetooth, Zigbee, Z-Wave, and Insteon.

In many cases, printed circuit boards can take up too much space so it is desirable to find configurations that decrease size without sacrificing capabilities. FIG. 3B is an alternative configuration for the printed circuit board 52 of FIG. 3A. The printed circuit board 54 takes on a dumbbell-like shape which produces a smaller footprint while retaining the same electronics and functionality as the larger printed circuit board 52 of FIG. 3A. The printed circuit board 54 includes a flexible ribbon cable 56 that allows for this more compact configuration. Specifically, FIG. 4 shows the printed circuit board 54 of FIG. 3B folded into a sandwich-like configuration. The resulting configuration may ultimately occupy roughly half the area of the printed circuit board 52 of FIG. 3A.

The compact printed circuit board 54 allows it to be mounted and integrated directly into an enclosure 58 of the solenoid 24 (FIG. 6A) or wrapped around the enclosure 58 of the solenoid 24 (FIG. 6B). In FIG. 5, there is shown a valve 22 with the solenoid 24 containing the printed circuit board 54 of FIG. 4. This demonstrates that all of the electronics (e.g., the transceiver 28, the sensor 26, the decoder 42 and the signal generator 50) can be integrated in the enclosure 58 of solenoid 24.

Referring now to FIG. 7, an example of a passive sensor 38 is shown as a flow sensor 39. Irrigation pipes 16 are secured to the inlet 32 and outlet 34 of the valve 22. The flow sensor can include a Hall Effect sensor 60 outside the pipe 16 and a turbine 62 with magnets in the pipe. The Hall Effect sensor 60 senses movement of the magnets of the turbine 62. The sensor node 20 can issue an electromagnetic wave of radio frequency 48 to the flow sensor 39 to cause the flow sensor to wake up and take flow measurements and transmit them back to the sensor node 20. The sensor node 20 can in turn transmit the flow data back to the controller 14 via the wireless solenoid mesh network 12. The controller 14 can then determine what the appropriate flow is running through the pipe 16 downstream of the valve 22. If the flow is more than normal during an irrigation event, then there is a leak in the system downstream. If there is flow when the valve is closed, such as between irrigation events, then the valve leaks.

Once the valve nodes 20 are configured to send messages and interpret those messages, the network of nodes (i.e., the wireless solenoid mesh network 12) becomes “smart,” and the valve nodes 20 are able to react in different ways based upon the messages being transmitted. For example, if a valve node 20 senses movement, it can send a message through the wireless solenoid mesh network 12 to the controller 14 where the controller 14 can make a decision to let a user know motion has been detected. This notification can be made via a PUSH notification to a mobile device carried by the user or to any other altering system established by the user, including a home security network.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the technological contribution. The actual scope of the protection sought is intended to be defined in the following claims.

What is claimed is:

1. An irrigation system comprising:
a plurality of valves;
a plurality of solenoids, at least one solenoid of the plurality of solenoids being associated with each of the plurality of valves;
a plurality of circuits, at least one circuit being associated with each of the plurality of solenoids;
a plurality of wireless transceivers, at least one wireless transceiver being in communication with each circuit of the plurality of solenoids; and
a mesh network being formed by the plurality of wireless transceivers for communication between solenoids.

2. The irrigation system of claim 1 further comprising at least one controller and the mesh network being in communication with the at least one controller.

3. The irrigation system of claim 2 wherein the at least one controller controls opening and closing of at least one of the plurality of valves.

4. The irrigation system of claim 1 wherein at least one of the plurality of solenoids includes a sensor to collect data.

5. The irrigation system of claim 4 further comprising at least one controller and wherein the mesh network communicates the data to the controller.

6. The irrigation system of claim 4 wherein the data relates to security.

7. The irrigation system of claim 4 wherein the data relates to environmental conditions.

8. The irrigation system of claim 1 further comprising at least one remote sensor spaced from at least one solenoid and wherein the at least one remote sensor and at least one solenoid communicate wirelessly to transmit and receive data.

9. The irrigation system of claim 8 wherein the at least one remote sensor having passive radio-frequency identification and wherein the at the least one solenoid capable of transmitting a signal to activate the at least one remote sensor to collect data and transmit the data to the at least one solenoid.

10. The irrigation system of claim 8 wherein the at least one sensor remains alert for incoming data from the at least one sensor, and the at least one sensor sends data upon a change in the data.

11. The irrigation system of claim 8 further comprising at least one controller and wherein the mesh network routes the data.

12. The irrigation system of claim 8 wherein the data relates to security.

13. The irrigation system of claim 12 wherein the data relates to flow conditions in at least a portion of the irrigation system, motion around at least a portion of the irrigation system or noise around at least a portion of the irrigation system.

14. The irrigation system of claim 8 wherein the data relates to environmental conditions.

15. The irrigation system of claim 14 wherein the data relates to ground moisture, temperature, humidity, solar radiation, light, rain detection, or rain accumulation.

16. The irrigation system of claim 1 wherein the mesh network has distributed intelligence to make decisions based on routed data.

17. An irrigation valve comprising:
a valve;
a solenoid associated with the valve to control opening and closing of the valve;
circuitry associated with the solenoid;
a wireless transceiver associated with the circuitry; and
the wireless transceiver capable of communicating with other wireless transceivers to form a wireless mesh network.

18. The irrigation valve of claim 17 further comprising a sensor to collect data in communication with the circuitry and wherein the data is transmitted by the wireless transceiver to a wireless mesh network.

19. The irrigation valve of claim 17 further comprising a wireless electrical power generator in communication with the circuitry, the wireless electrical power generator being capable of broadcasting a signal that activates a passive device.

20. The irrigation valve of claim 19 wherein the transceiver is capable of receiving data from a passive device.

21. The irrigation valve of claim 20 wherein data from a passive device is transmitted by the wireless transceiver to a wireless mesh network.
